(19) United States
(12) Patent Application Publication
(10) Pub. No.: US 2016/0232892 A1
(43) Pub. Date: Aug. 11, 2016

(54) METHOD AND APPARATUS OF EXPANDING SPEECH RECOGNITION DATABASE

(71) Applicant: Electronics and Telecommunications Research Institute, Daejeon (KR)

(72) Inventors: Yun-Joo KIM, Seongnam-si (KR); Ju-Yeob KIM, Daejeon (KR); Tae-Joong KIM, Daejeon (KR)

(73) Assignee: Electronics and Telecommunications Research Institute, Daejeon (KR)

(21) Appl. No.: 14/991,716

(22) Filed: Jan. 8, 2016

(30) Foreign Application Priority Data
Feb. 11, 2015 (KR) 10-2015-0021162

(51) Int. Cl. G10L 15/06; G10L 15/183; G10L 15/02; G06F 17/27; G10L 15/14

(52) U.S. Cl. CPC G10L 15/063; G06F 17/2735; G06F 17/277; G10L 15/14; G10L 15/02; G10L 15/183; G10L 2015/0635; G10L 2015/025

(57) ABSTRACT

Disclosed herein are a method and an apparatus of expanding a speech recognition database used for speech recognition. The method of expanding a speech recognition database includes generating a pronunciation text from a corpus; confirming whether or not a non-registered word that is not registered in advance in a pronunciation dictionary among words included in the pronunciation text is present; generating lexical model information on the corresponding non-registered word with reference to a built-up acoustic model in the case in which the non-registered word is present as a confirmation result; and adding the generated lexical model information to a built-up lexical model. According to exemplary embodiments of the present invention, various speeches may be recognized in a stand-along speech recognizer in which an infrastructure is insufficient.

### CROSS REFERENCE TO RELATED APPLICATION

This application claims the benefit of Korean Patent Application No. 10-2015-0021162, filed on Feb. 11, 2015, which is hereby incorporated by reference in its entirety into this application.

### BACKGROUND

1. Technical Field

Exemplary embodiments of the present invention relate to a method and an apparatus of expanding a speech recognition database used for speech recognition.

2. Description of the Related Art

Due to a network environment having an increased processing capacity based on a cloud network, improvement of performance of hardware of a processor, a memory, and the like, an increase in the necessity for various user interface technologies, speech recognition has been prominent in various application fields.

Particularly, recently, speech recognition technologies based on the cloud network have been actively developed in order to rapidly process a large capacity natural language. However, a speech recognition technology in a field in which an infrastructure is insufficient or an application is restrictive, particularly, in a device level in which a network is not used has been still used restrictively.

Meanwhile, various technical approaches associated with training, an operation, and the like, of a database have been performed in order to improve the performance of speech recognition.

A general speech recognition database training process according to the related art requires training data on which feature the respective pronunciation bundles have as a speech signal based on one language, words used in the language, pronunciation bundles of the words, a connection relationship between the words depending on a language rule used in the language. An analysis on a training process and a training result using all of these data should be performed once or more in order to generate a pronunciation dictionary, an acoustic model, a language model, and the like, that may be applied as a reference of the speech recognition.

Therefore, when new words such as a loanword or a new word are intended to be included in a speech recognition target, a complicated speech recognition database training process is required every time. This will be described with reference to FIG. 1A and FIG. 1B. FIG. 1A and FIG. 1B are illustrative views for describing a method of building up a speech recognition database according to the related art.

For example, a situation in which a speech recognition database is built up by performing training based on speech corpuses is assumed, as illustrated in FIG. 1A. In this case, in the case of intending to adding a speech recognition database for any additional corpuses, a speech recognition database should be newly built up by performing new training for both of existing speech corpuses and new additional corpuses, as illustrated in FIG. 1B.

### SUMMARY

Exemplary embodiments of the present invention provide a method of expanding a built-up speech recognition database so that a new recognition unit may be included in a target of speech recognition.

According to an exemplary embodiment of the present invention, a method of expanding a speech recognition database includes: generating a pronunciation text from a corpus; confirming whether or not a non-registered word that is not registered in advance in a pronunciation dictionary among words included in the pronunciation text is present; generating lexical model information on the corresponding non-registered word with reference to a built-up acoustic model in the case in which the non-registered word is present as a confirmation result; and adding the generated lexical model information to a built-up lexical model.

The method of expanding a speech recognition database may further include adding a pronunciation text of the non-registered word to the pronunciation dictionary.

The method of expanding a speech recognition database may further include: determining a transition probability between adjacent phonemes included in the non-registered word based on probability values of candidate groups for a phoneme positioned before among the adjacent phonemes; and correcting the built-up acoustic model based on the determined transition probability.

The determining of the transition probability between the adjacent phonemes may include determining that the highest transition probability among transition probabilities present in the candidate groups is the transition probability between the adjacent phonemes.

The generating of the lexical model information may include generating lexical model information on adjacent words based on a relationship between the adjacent words in the case in which the non-registered word and a registered word are adjacent to each other or non-registered words are adjacent to each other on the pronunciation text.

The generating of the lexical model information may include adding a word positioned behind among the adjacent words to a group of next estimated words of a word positioned before among the adjacent words.

The generating of the lexical model information may include determining a transition probability between the adjacent words based on probability values of candidate groups for the word positioned before among the adjacent words.

The determining of the transition probability between the adjacent words may include determining that the highest transition probability among transition probabilities present in the candidate groups is the transition probability between the adjacent words.

The method of expanding a speech recognition database may further include: confirming whether or not a relationship between adjacent words adjacent to each other among registered words included in the pronunciation text is reflected in a built-up language model; generating language model information indicating the relationship between the adjacent words in the case in which the relationship between the adjacent words is not reflected in the built-up language model; and adding the generated language model information to the built-up language model.

The generating of the language model information may include defining the adjacent words as a connection group of words.

The generating of the language model information may include determining a transition probability between the adjacent words based on probability values of candidate groups for a word positioned before among the adjacent words.

The determining of the transition probability between the adjacent words may include determining that the highest transition probability among transition probabilities present in the candidate groups is the transition probability between the adjacent words.

According to an exemplary embodiment of the present invention, an apparatus of expanding a speech recognition database includes: a processor; and a memory, wherein commands for expanding the speech recognition database are stored in the memory, and the commands include commands allowing the processor to perform the following operations when being executed by the processor: an operation of generating a pronunciation text from a corpus; an operation of confirming whether or not a non-registered word that is not registered in advance in a pronunciation dictionary among words included in the pronunciation text is present; an operation of generating lexical model information on the corresponding non-registered word with reference to a built-up acoustic model in the case in which the non-registered word is present as a confirmation result; and an operation of adding the generated lexical model information to a built-up lexical model.

### BRIEF DESCRIPTION OF THE DRAWINGS

FIG. 1A and FIG. 1B are illustrative views for describing a method of building up a speech recognition database according to the related art.

FIG. 2 is a flow chart for describing a speech recognition database training process.

FIG. 3 is a conceptual diagram for describing a method of expanding a speech recognition database according to an exemplary embodiment of the present invention.

FIG. 4 is a flow chart for describing the method of expanding a speech recognition database according to an exemplary embodiment of the present invention.

FIG. 5 is an illustrative view for describing a pronunciation text processing method according to an exemplary embodiment of the present invention.

FIG. 6A, FIG. 6B and FIG. 6C are illustrative views for describing an acoustic model processing method for a non-registered word according to an exemplary embodiment of the present invention.

FIG. 7A, FIG. 7B, FIG. 7C and FIG. 7D are illustrative views for describing a lexical model processing method according to an exemplary embodiment of the present invention.

FIG. 8 is an illustrative view for describing information included in a hidden Markov model (HMM) based speech recognition database.

FIG. 9 is a block diagram for describing an apparatus of expanding a speech recognition database according to an exemplary embodiment of the present invention.

### DESCRIPTION OF THE EXEMPLARY EMBODIMENTS

Hereinafter, in describing exemplary embodiments of the present invention, when it is decided that a detailed description for the known functions or components related to the present invention may unnecessarily obscure the gist of the present invention, the detailed description will be omitted.

Exemplary embodiments of the present invention provide a method of correcting a built-up speech recognition database or adding a new speech recognition database in order to allow a new recognition unit (that may be a phoneme, a syllable, a word, or a sentence) to be included in a target of speech recognition.

Exemplary embodiments of the present invention may be applied to a speech recognition system using a statistical method called a hidden Markov model (HMM) as a speech recognition algorithm.

Hereinafter, in describing exemplary embodiments of the present invention, a speech recognition database is used as the meaning including at least one of a pronunciation dictionary, an acoustic model, a lexical model, and a language model.

Hereinafter, in describing exemplary embodiments of the present invention, a description will be provided under the assumption that a recognition unit is a word. However, the recognition unit may also be a phoneme, a syllable, or a sentence, as described above.

Hereinafter, exemplary embodiments of the present invention will be described with reference to the accompanying drawings.

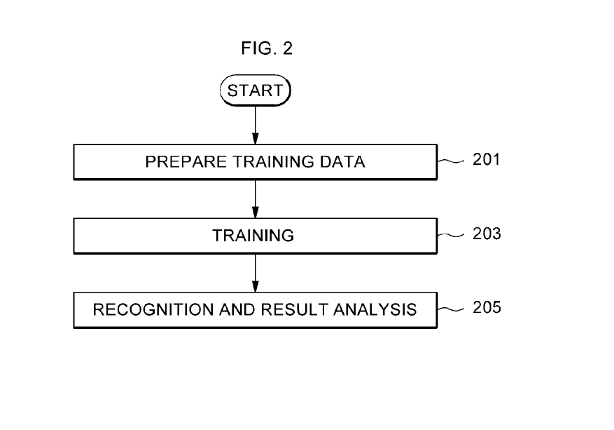

FIG. 2 is a flow chart for describing a speech recognition database training process.

In Step 201, training data are prepared.

In detail in Step 201, training word list that are to be trained is selected. Words included in the training word list are transcribed in a phoneme unit, and a pronunciation dictionary including all the words included in the training word list is constituted. Speech data on the respective phonemes are recorded so as to correspond to the corresponding phonemes.

In addition, a network list between the words included in the training word list is generated so as to be grammatically correct. In the network list, a connection (or arc) relationship between the words included in the training word list is defined. For example, it is defined which words may be positioned before or after any word. The connection represents a transition between words.

In Step 203, training is performed.

In detail, in Step 203, an acoustic model is generated based on the pronunciation dictionary, speech data, and feature vectors extracted from the speech data.

In addition, a lexical model and a language model including a transition probability that the words will be connected to each other so that the words included in the training word list may be grammatically correctly recognized are generated.

In Step 205, a test speech is recognized using the acoustic model, the lexical model, and the language model generated in Step 203, and reliability of the acoustic model, the lexical model, and the language model is evaluated through an analysis of a recognition result.

In order to obtain a better recognition result, processes of Step 201 to Step 205 may be repeated, and finally used models may be determined among the acoustic models, the lexical models, and the language models generated by the repetition.

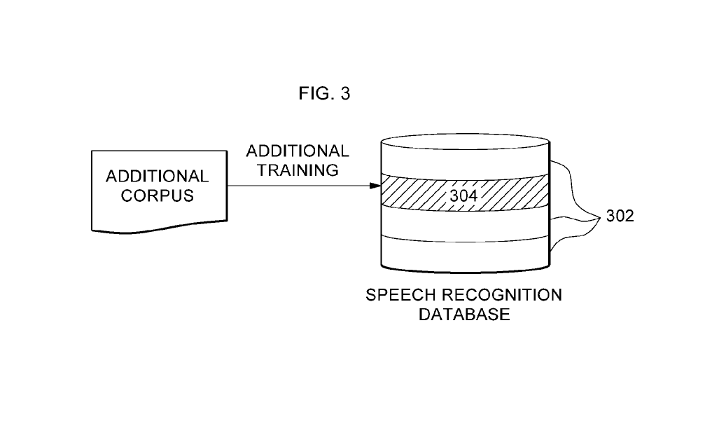

FIG. 3 is a conceptual diagram for describing a method of expanding a speech recognition database according to an exemplary embodiment of the present invention.

According to an exemplary embodiment of the present invention, in the case of intending to add a new word or a new sentence to a range of speech recognition, new acoustic model information, lexical model information, and language model information may be generated based on the word or the sentence that is intended to be added (hereinafter, referred to as an additional corpus) and a built-up speech recognition database. In addition, the built-up speech recognition database may be expanded using the generated model information. Referring to FIG. 3, it may be appreciated that new model information 304 has been reflected in a built-up speech recognition database 302.

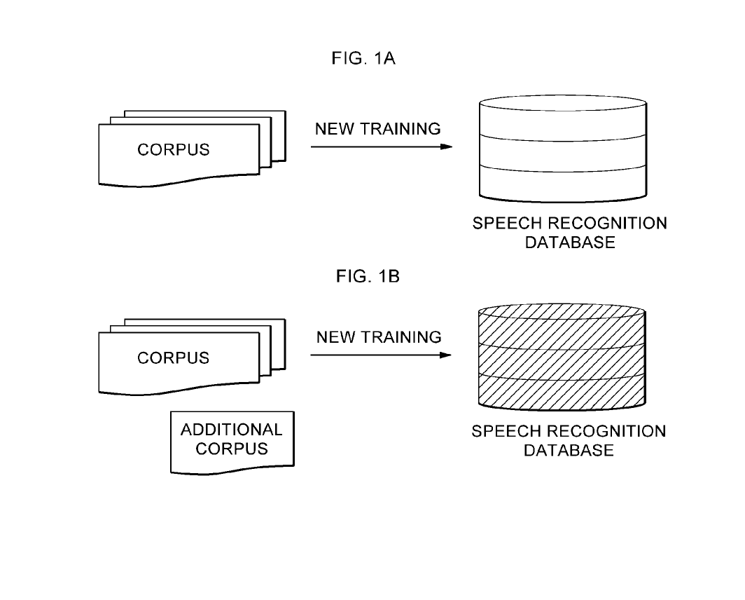

A range of the speech recognition may be simply expanded without performing a complicated training method for all of the corpuses, as compared with the method according to the related art described with reference to FIG. 1B.

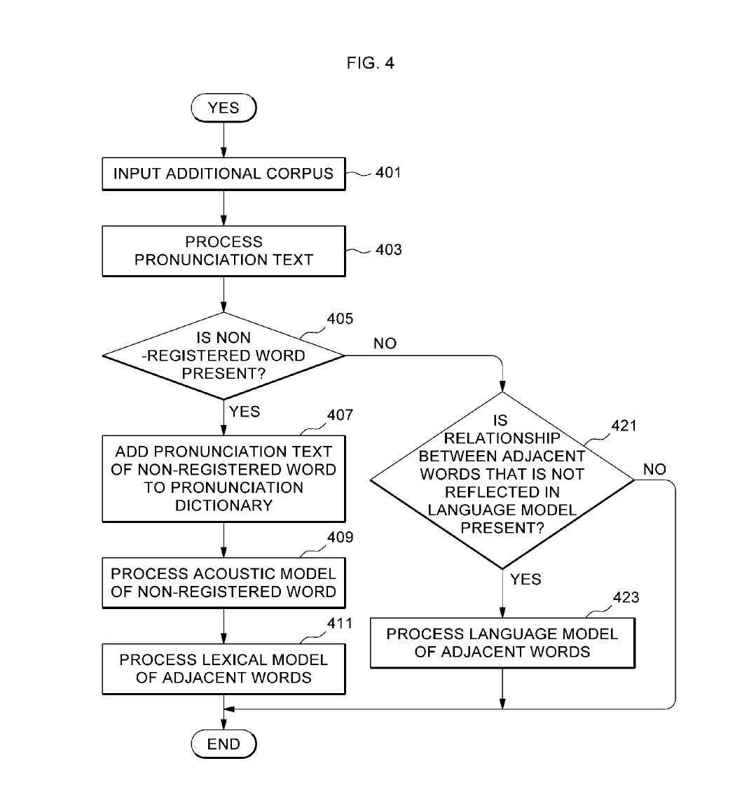

FIG. 4 is a flow chart for describing the method of expanding a speech recognition database according to an exemplary embodiment of the present invention. According to exemplary embodiments, at least one of Step 401 to Step 425 may be omitted. According to exemplary embodiments, at least one of Step 401 to Step 425 may be performed before another step or be performed after another Step.

In Step 401, an apparatus of expanding a speech recognition database receives an additional corpus used to expand the speech recognition database. The additional corpus may have a text form.

In Step 403, the apparatus of expanding a speech recognition database performs pronunciation text processing on the received additional corpus.

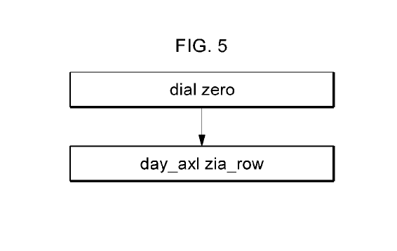

For example, in the case in which the received additional corpus is constituted of Korean, the apparatus of expanding a speech recognition database generates a Korean pronunciation text transcribed in phonetic script. In addition, the Korean pronunciation text is converted into an English pronunciation text. In the case in which the additional corpus is English, the apparatus of expanding a speech recognition database directly generates an English pronunciation text from the additional corpus. Hereinafter, for convenience of explanation, the English pronunciation text will be called a pronunciation text. A pronunciation text processing process will be described with reference to FIG. 5.

FIG. 5 is an illustrative view for describing a pronunciation text processing method according to an exemplary embodiment of the present invention.

In an exemplary embodiment described with reference to FIG. 5, a case in which an additional corpus “dial zero” constituted of English is input is assumed for convenience of explanation.

The apparatus of expanding a speech recognition database generates a pronunciation text of words included in the additional corpus when the additional corpus is input. Referring to FIG. 5, it may be appreciated that a pronunciation text “day_axl zia_row” has been generated from the additional corpus “dial zero”. Various methods that have been used in the related art may be used to generate the pronunciation text, and a detailed description therefor will be omitted herein.

Again referring to FIG. 4, in Step 405, the apparatus of expanding a speech recognition database confirms whether or not a non-registered word that is not registered in a pronunciation dictionary is included in the additional corpus on which the pronunciation text processing is performed. The method of expanding a speech recognition database proceeds to Step 407 in the case in which the non-registered word that is not registered in the pronunciation dictionary is present, and proceeds to Step 421 otherwise.

In Step 407, the apparatus of expanding a speech recognition database maps the non-registered word and a pronunciation text of the corresponding non-registered word to each other and adds the pronunciation text of the non-registered word to the pronunciation dictionary.

For example, a case in which words transcribed as “day_axl” and “zia row” in the pronunciation text “day_axl zia_row” are not registered in the pronunciation dictionary is assumed. In this case, the apparatus of expanding a speech recognition database maps a non-registered word “dial” and a pronunciation text “day_axl” of the corresponding non-registered word to each other and adds the pronunciation text of the non-registered word to the pronunciation dictionary. Likewise, the apparatus of expanding a speech recognition database maps a non-registered word “zero” and a pronunciation text “zia_row” of the corresponding non-registered word to each other and adds the pronunciation text of the non-registered word to the pronunciation dictionary.

In Step 409, the apparatus of expanding a speech recognition database performs acoustic model processing on the non-registered word.

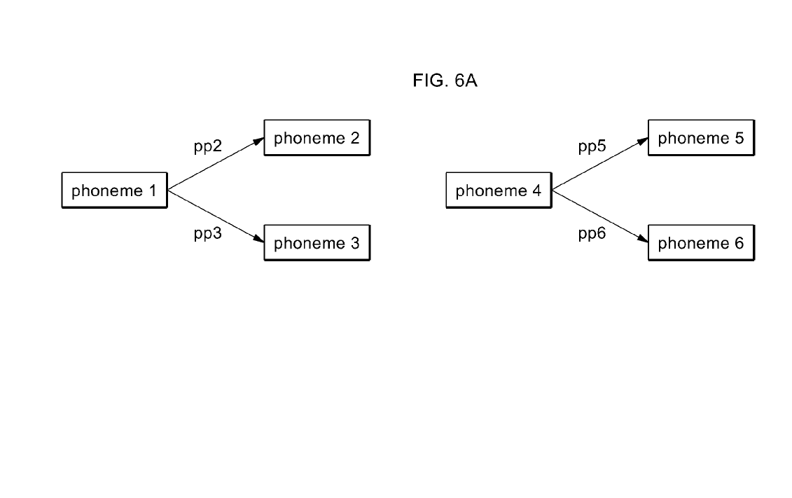

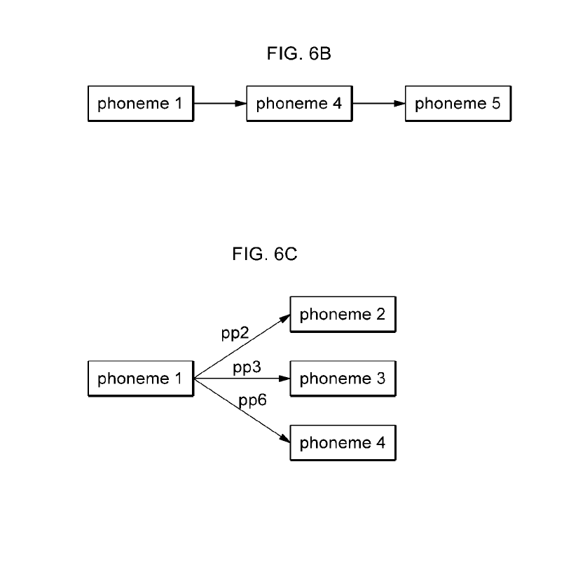

The performing of the acoustic model processing on the non-registered word may include, for example, correcting shared state information of a built-up acoustic model. This will be described with reference to FIG. 6A, FIG. 6B and FIG. 6C.

FIG. 6A, FIG. 6B and FIG. 6C are illustrative views for describing an acoustic model processing method for a non-registered word according to an exemplary embodiment of the present invention.

As illustrated in FIG. 6A, it is assumed that phoneme 2 and phoneme 3 are present as candidate phonemes for phoneme 1 and phoneme 5 and phoneme 6 are present as candidate phonemes for phoneme 4, in the built-up acoustic model.

In this situation, in the case in which a non-registered word constituted of phoneme 1-phoneme 4-phoneme 5 is input, the apparatus of expanding a speech recognition database may correct shared state information of the phoneme 1 so that the phoneme 4 is included as a candidate phoneme for the phoneme 1.

To this end, the apparatus of expanding a speech recognition database may determine a transition probability that the phoneme 4 will be positioned after the phoneme 1. The transition probability may be determined based on transition probabilities of candidate groups {(phoneme 1-phoneme 2), (phoneme 1-phoneme 3), (phoneme 4-phoneme5), (phoneme 4-phoneme 6)} or be determined to a preset value.

In the case in which the transition probability is determined based on probability values of the candidate groups, the apparatus of expanding a speech recognition database may select the highest transition probability among transition probabilities present in the candidate groups and determine that the selected transition probability is a transition probability for the phoneme 4 in order to increase a probability that the phoneme 4 will be recognized as the candidate phoneme for the phoneme 1.

For example, when it is assumed that pp6 among transition probabilities pp2, pp3, pp5, and pp6 of the candidate groups is highest, the apparatus of expanding a speech recognition database may determine that the transition probability for the phoneme 4 is pp6, as illustrated in FIG. 6C. In addition, the apparatus of expanding a speech recognition database may correct the shared state information of the phoneme 1 depending on the determined probability. The shared state information includes an average value or a variance value required for calculating an emission probability. Therefore, the apparatus of expanding a speech recognition database may correct the average value or the variance value included in the shared state information depending on the determined transition probability.

In exemplary embodiments of the present invention, the candidate group may mean a set of phonemes that may be connected to a specific phoneme or a set of words that may be connected to a specific word. The candidate group for the specific phoneme may be constituted of phonemes having higher probabilities that they will be connected to the corresponding specific phoneme as compared with phonemes that are not included in the corresponding candidate group. The candidate group for the specific word may be constituted of words having higher probabilities that they will be connected to the corresponding specific word as compared with words that are not included in the corresponding candidate group. For example, in a sentence having a subject-predicate structure, a candidate group of a word corresponding to the subject does not include nominal words, but may include only verbal words.

The candidate group may be defined by a user in the training data preparing process described with reference to FIG. 2 or be inferred depending on repetition of the training process described with reference to FIG. 2.

Again referring to FIG. 4, in Step 411, the apparatus of expanding a speech recognition database performs lexical model processing on adjacent words.

The performing of the lexical model processing on the adjacent words may include, for example, generating lexical model information on the adjacent words based on a relationship between the corresponding adjacent words and adding the generated lexical model information to a built-up lexical model. The generating of the lexical model information on the adjacent words may include, for example, adding words positioned behind among the corresponding adjacent words to a group of next estimated words of a word positioned before among the corresponding adjacent words. The group of next estimated words means a set of words that may be positioned behind the corresponding word.

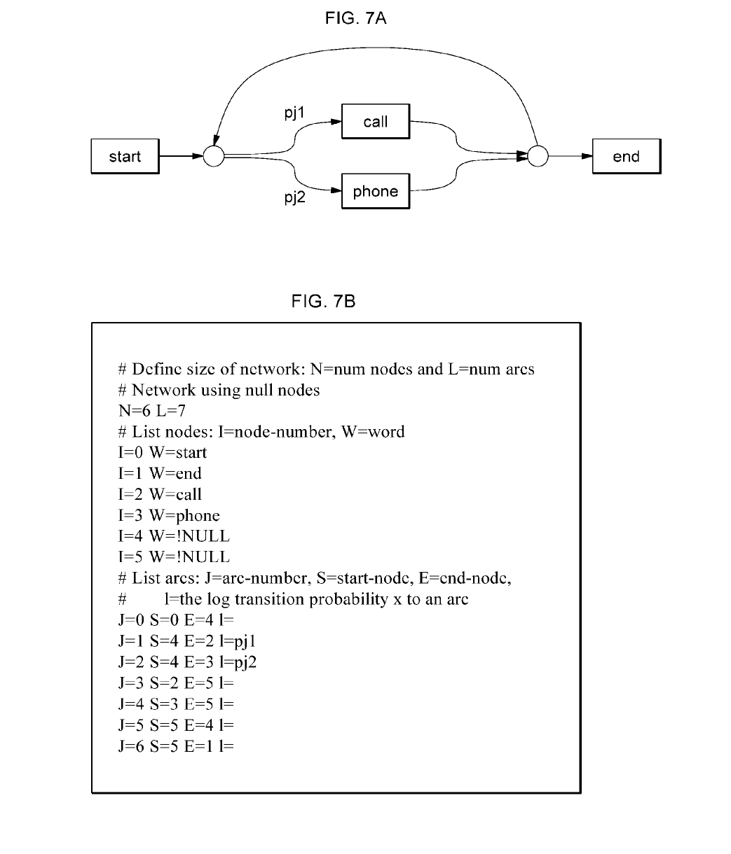

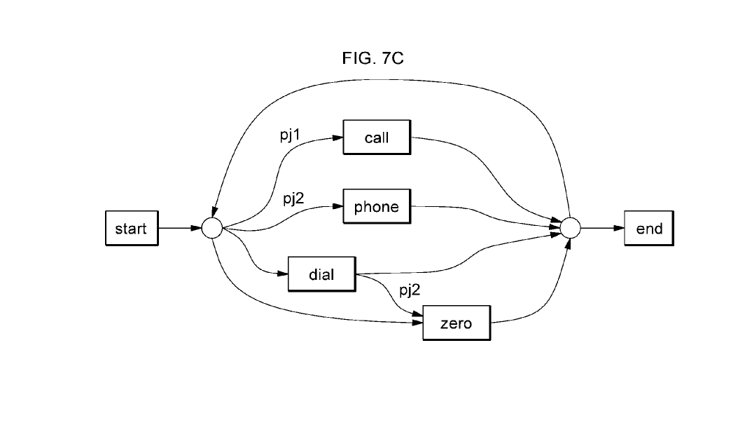

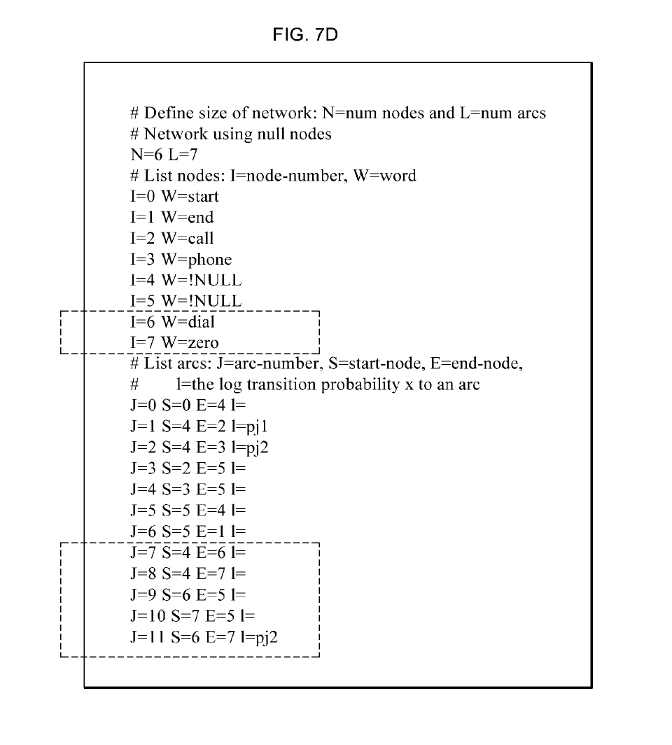

The lexical model information may include, for example, at least one of the number of phonemes constituting the respective words, a phoneme sequence constituting the corresponding word, and a group of next estimated words that may be positioned after the corresponding word. A lexical model processing method will be described with reference to FIG. 7A, FIG. 7B, FIG. 7C and FIG. 7D.

FIG. 7A, FIG. 7B, FIG. 7C and FIG. 7D are illustrative views for describing a lexical model processing method according to an exemplary embodiment of the present invention.

First, as illustrated in FIG. 7A and FIG. 7B, a situation in which a word lattice including words “call” and “phone” is present is assumed. The word lattice includes words W, indices I of the respective words, arcs indicating a transition between the words, and probability information on the respective arcs.

In this situation, a situation in which new non-registered words “dial” and “zero” are input is assumed. In this case, the apparatus of expanding a speech recognition database adds the corresponding non-registered words to the word lattice, as illustrated in FIG. 7C and FIG. 7D.

In addition, the apparatus of expanding a speech recognition database adds the word “zero” positioned behind to a group of next estimated words in lexical model information on the word “dial” positioned before.

In addition, the apparatus of expanding a speech recognition database determines a transition probability between the non-registered words, and adds the determined transition probability to the word lattice. The transition probability between the non-registered words may be determined based on the probability values of the candidate groups or be determined to be a preset value.

In the case in which the transition probability between the non-registered words is determined based on the probability values of the candidate groups, the apparatus of expanding a speech recognition database may select the highest transition probability among transition probabilities present in the candidate groups in order to increase a probability that the word “zero” positioned behind will be recognized as a candidate word for the word “dial” positioned before. In addition, the apparatus of expanding a speech recognition database may determine that the selected transition probability is a transition probability of the word “dial” for the word “zero”, that is, a probability that the word “zero” will be positioned after the word “dial”.

For example, when it is assumed that the highest transition probability among transition probabilities pj1 and pj2 present in one candidate group is pj2, the apparatus of expanding a speech recognition database may determine that the transition probability of the word “dial” for the word “zero” is pj2, as illustrated in FIG. 7C and FIG. 7D.

Meanwhile, the transition probability may be updated depending on statistical characteristics obtained in a process of performing the speech recognition. For example, in the case in which the speech recognition is continuously performed, such that candidate words that may be positioned after the word “dial” are added, transition probabilities of the word “dial” for the respective candidate words may be normalized In addition, the transition probabilities of the word “dial” for the respective candidate words may be updated in a normalizing process.

For example, a situation in which only “zero” is present as the candidate word that may be positioned after the word “dial” and the transition probability of the word “dial” for the candidate word “zero” is 0.2 is assumed. In addition, it is assumed that the speech recognition was additionally performed, such that a word “one” and a word “two” were added as candidate words that may be positioned after the word “dial”, a transition probability of the word “dial” for the candidate word “one” was determined to be 0.5, and a transition probability of the word “dial” for the candidate word “two” was determined to be 0.8.

In this case, the apparatus of expanding a speech recognition database may normalize the transition probabilities of the word “dial” for the candidate words. Therefore, the transition probability of the word “dial” for the candidate word “zero” may be updated to 1.333, the transition probability of the word “dial” for the candidate word “one” may be updated to 3.333, and the transition probability of the word “dial” for the candidate word “two” may be updated to 5.333.

The normalization and the update of the transition probabilities may be similarly applied to the transition probabilities between the phonemes described above, and may be similarly applied to transition probabilities between adjacent words defined as a connection group of words to be described below.

Meanwhile, although an example of a case in which all the adjacent words are the non-registered words has been described in an exemplary embodiment described with reference to FIG. 7A, FIG. 7B, FIG. 7C and FIG. 7D, exemplary embodiments of the present invention may be similarly applied to a case in which any one of the adjacent words is a registered word.

Again referring to FIG. 4, in Step 421, the apparatus of expanding a speech recognition database decides whether or not a relationship between adjacent words that are not reflected in a built-up language model is present in the additional corpus on which the pronunciation text processing is performed. In the case in which the relationship between adjacent words that is not reflected in the built-up language model is present in the additional corpus on which the pronunciation text processing is performed, the method of expanding a speech recognition database proceeds to Step 423.

In Step 423, the apparatus of expanding a speech recognition database performs language model processing on adjacent words between which a relationship is not reflected on the built-up language model.

The performing of the language model processing may include, for example, generating language model information indicating a relationship between the corresponding adjacent words and adding the generated language model information to the built-up language model.

The language model information may include, for example, at least one of the connection group of words, the previous estimated words, the next estimated words, and a transition probability between the respective words.

The connection group of words means a set of adjacent words between which a connection frequency appears to be high in a process in which the training or the speech recognition is performed.

The previous estimated word means a word that may be positioned before the corresponding word.

The next estimated word means a word that may be positioned behind the corresponding word.

The apparatus of expanding a speech recognition database may define the adjacent words as the connection group of words, and determine a transition probability between the corresponding adjacent words. The transition probability between the corresponding adjacent words may be determined based on the probability values of the candidate groups or be determined to be a preset value.

In the case in which the transition probability between the corresponding adjacent words is determined based on the probability values of the candidate groups, the apparatus of expanding a speech recognition database may select the highest transition probability among transition probabilities of the candidate groups and determine that the selected transition probability is a transition probability for the corresponding adjacent words in order to increase a probability that a word positioned behind among the adjacent words will be recognized as a candidate word for a word positioned before among the corresponding adjacent words.

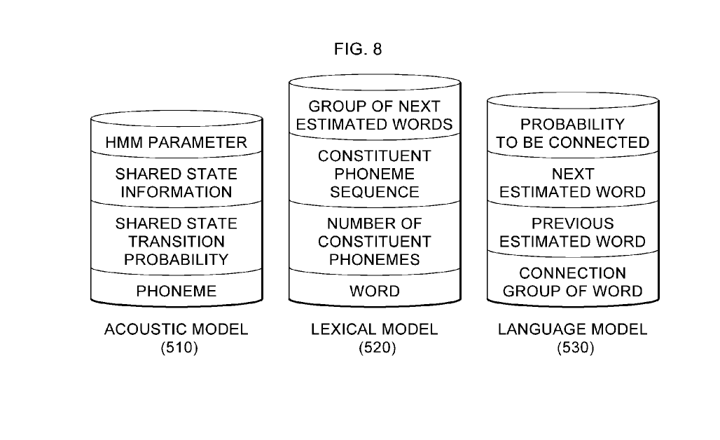

FIG. 8 is an illustrative view for describing information included in an HMM based speech recognition database.

An acoustic model 510 includes phonemes, shared state transition probabilities for the respective phonemes, shared state information, HMM parameters, and the like.

A lexical model 520 may include information on words, the number of phonemes constituting the respective words, phoneme sequences constituting the respective words, a group of next estimated words, and the like.

A language model 530 includes the connection group of words, the previous estimated words, the next estimated words, and a probability that words will be connected to each other.

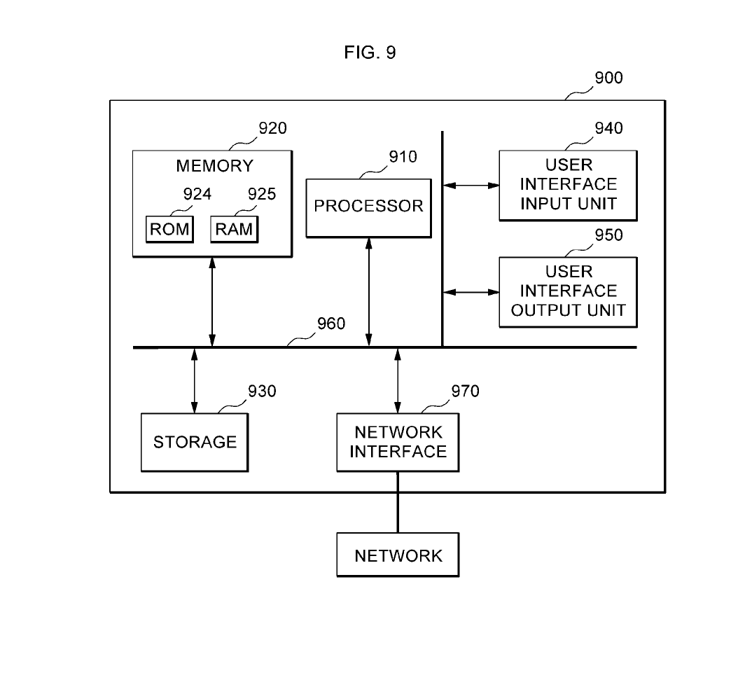

Exemplary embodiments of the present invention may be implemented by, for example, a computer-readable recording medium in a computer system. As illustrated in FIG. 9, the computer system 900 may include at least one of one or more processors 910, a memory 920, a storing unit 930, a user interface input unit 940, and a user interface output unit 950, which may communicate with each other through a bus 960. In addition, the computer system 900 may further include a network interface 970 for accessing a network. The processor 910 may be a central processing unit (CPU) or a semiconductor element executing processing commands stored in the memory 920 and/or the storing unit 930. The memory 920 and the storing unit 930 may include various types of volatile/non-volatile storage media. For example, the memory may include a read only memory (ROM) 924 and a random access memory (RAM) 925.

According to exemplary embodiments of the present invention, various speeches may be recognized in a stand-along speech recognizer in which an infrastructure is insufficient.

According to exemplary embodiments of the present invention, a new recognition unit may be added to a target of speech recognition without deteriorating performance of a built-up speech recognition database.

Therefore, exemplary embodiments of the present invention may be implemented by a method implemented by a computer or a non-volatile computer recording medium in which computer executable commands are stored. The commands may perform a method according to an exemplary embodiment of the present invention when it is executed by a processor.

What is claimed is:

1. A method of expanding a speech recognition database, comprising:
generating a pronunciation text from a corpus;
confirming whether or not a non-registered word that is not registered in advance in a pronunciation dictionary among words included in the pronunciation text is present;
generating lexical model information on the corresponding non-registered word with reference to a built-up acoustic model in the case in which the non-registered word is present as a confirmation result; and
adding the generated lexical model information to a built-up lexical model.

2. The method of expanding a speech recognition database of claim 1, further comprising adding a pronunciation text of the non-registered word to the pronunciation dictionary.

3. The method of expanding a speech recognition database of claim 1, further comprising:
determining a transition probability between adjacent phonemes included in the non-registered word based on probability values of candidate groups for a phoneme positioned before among the adjacent phonemes; and
correcting the built-up acoustic model based on the determined transition probability.

4. The method of expanding a speech recognition database of claim 3, wherein the determining of the transition probability between the adjacent phonemes includes determining that the highest transition probability among transition probabilities present in the candidate groups is the transition probability between the adjacent phonemes.

5. The method of expanding a speech recognition database of claim 1, wherein the generating of the lexical model information includes generating lexical model information on adjacent words based on a relationship between the adjacent words in the case in which the non-registered word and a registered word are adjacent to each other or non-registered words are adjacent to each other on the pronunciation text.

6. The method of expanding a speech recognition database of claim 5, wherein the generating of the lexical model information includes adding a word positioned behind among the adjacent words to a group of next estimated words of a word positioned before among the adjacent words.

7. The method of expanding a speech recognition database of claim 6, wherein the generating of the lexical model information includes determining a transition probability between the adjacent words based on probability values of candidate groups for the word positioned before among the adjacent words.

8. The method of expanding a speech recognition database of claim 7, wherein the determining of the transition probability between the adjacent words includes determining that the highest transition probability among transition probabilities present in the candidate groups is the transition probability between the adjacent words.

9. The method of expanding a speech recognition database of claim 1, further comprising:
confirming whether or not a relationship between adjacent words adjacent to each other among registered words included in the pronunciation text is reflected in a built-up language model;
generating language model information indicating the relationship between the adjacent words in the case in which the relationship between the adjacent words is not reflected in the built-up language model; and
adding the generated language model information to the built-up language model.

10. The method of expanding a speech recognition database of claim 9, wherein the generating of the language model information includes defining the adjacent words as a connection group of words.

11. The method of expanding a speech recognition database of claim 10, wherein the generating of the language model information includes determining a transition probability between the adjacent words based on probability values of candidate groups for a word positioned before among the adjacent words.

12. The method of expanding a speech recognition database of claim 11, wherein the determining of the transition probability between the adjacent words includes determining that the highest transition probability among transition probabilities present in the candidate groups is the transition probability between the adjacent words.

13. An apparatus of expanding a speech recognition database comprising:
a processor; and
a memory,
wherein commands for expanding the speech recognition database are stored in the memory, and
the commands include commands allowing the processor to perform the following operations when being executed by the processor:
an operation of generating a pronunciation text from a corpus;
an operation of confirming whether or not a non-registered word that is not registered in advance in a pronunciation dictionary among words included in the pronunciation text is present;
an operation of generating lexical model information on the corresponding non-registered word with reference to a built-up acoustic model in the case in which the non-registered word is present as a confirmation result; and
an operation of adding the generated lexical model information to a built-up lexical model.

14. The apparatus of expanding a speech recognition database of claim 13, wherein the commands include commands allowing the processor to perform the following operations:
an operation of determining a transition probability between adjacent phonemes included in the non-registered word based on probability values of candidate groups for a phoneme positioned before among the adjacent phonemes; and
an operation of correcting the built-up acoustic model based on the determined transition probability.

15. The apparatus of expanding a speech recognition database of claim 13, wherein the commands include commands allowing the processor to perform the following operation:
an operation of generating lexical model information on adjacent words based on a relationship between the adjacent words in the case in which the non-registered word and a registered word are adjacent to each other or non-registered words are adjacent to each other on the pronunciation text.

16. The apparatus of expanding a speech recognition database of claim 15, wherein the commands include commands allowing the processor to perform the following operation:
an operation of adding a word positioned behind among the adjacent words to a group of next estimated words of a word positioned before among the adjacent words.

17. The apparatus of expanding a speech recognition database of claim 16, wherein the commands include commands allowing the processor to perform the following operation:
an operation of determining a transition probability between the adjacent words based on probability values of candidate groups for the word positioned before among the adjacent words.

18. The apparatus of expanding a speech recognition database of claim 13, wherein the commands include commands allowing the processor to perform the following operations:
an operation of confirming whether or not a relationship between adjacent words adjacent to each other among registered words included in the pronunciation text is reflected in a built-up language model;
an operation of generating language model information indicating the relationship between the adjacent words in the case in which the relationship between the adjacent words is not reflected in the built-up language model; and
an operation of adding the generated language model information to the built-up language model.

19. The apparatus of expanding a speech recognition database of claim 18, wherein the commands include commands allowing the processor to perform the following operation:
an operation of defiling the adjacent words as a connection group of words.

20. The apparatus of expanding a speech recognition database of claim 19, wherein the commands include commands allowing the processor to perform the following operation:
an operation of determining a transition probability between the adjacent words based on probability values of candidate groups for a word positioned before among the adjacent words.
